(19) United States
(12) Patent Application Publication
(10) Pub. No.: US 2009/0208053 A1
(43) Pub. Date: Aug. 20, 2009

(54) AUTOMATIC IDENTIFICATION AND REMOVAL OF OBJECTS IN AN IMAGE, SUCH AS WIRES IN A FRAME OF VIDEO

(76) Inventor: Benjamin Kent, London (GB)

Correspondence Address: PERKINS COIE LLP;PATENT-SEA, P.O. BOX 1247, SEATTLE, WA, 98111-1247, US

(21) Appl. No.: 12/033,729

(22) Filed: Feb. 19, 2008

(51) Int. Cl. G06K 9/00

(52) U.S. Cl. 382/103

(57) ABSTRACT

A wire tracking system is described that provides a method and system for automatically locating wires in a digital image and tracking the located wires through a sequence of digital images. The wire tracking system is particularly good at removing wires from complex shots where background replacement is difficult. The wire tracking system performs complex signal processing to automatically remove the wire from the original image while preserving grain and background detail. Thus, the wire tracking system provides a reliable method of automatically identifying wires and replacing the wires with a reconstructed background image, and frees artists to make other enhancements to the scene.

### BACKGROUND

Wires are often used in movie production to support actors who are performing dangerous or physically impossible stunts. In order to maintain a sense of realism, it is necessary to remove these wires from each frame of the film in post-production. Wire removal is a visual effects technique used to remove wires in films. Wire removal can be partly automated through various forms of keying, or each frame can be edited manually. Early movies first filmed the live action plates of actors or models suspended on wires in front of a green (or other uniform color) screen. Artists then erased the wires frame by frame by manually painting green over the wires in the film. The backdrop was added later, so the artist did not have to worry about erasing the backdrop when painting over the wires. This task could also be accomplished automatically with a computer. It was often possible in these early movies for the viewer to realize that the actor was filmed separately from the background, taking away from the realism of the scene.

Recent movies forego filming in front of a green screen in order to create much more dynamic action sequences where the actors interact with the background. To remove the wires, an artist often hand-paints out the lines by filling in the parts of the background that were obscured by the wire. This can be an arduous task. A typical movie is filmed at a frame rate of 24 frames per second, and a particular sequence using wires may be many minutes long. Thus, the artist may have thousands of frames to paint to remove the wires.

In order to speed up this process The Foundry created its F_WireRemoval plug-in for Furnace 1.0 in 2003. When manually positioned over the wire by a user of the plug-in, this tool would automatically reconstruct the obscured data by looking at the data from previous or subsequent frames. The artist could either manually position the tool or ask the software to attempt to automatically track the wire using basic recognition techniques. The tracking seldom worked however, and The Foundry removed this functionality in Furnace 2.0. Thus, the onus of positioning the tool fell to the artist, a potentially time-consuming task as sequences could comprise thousands of frames.

There is a need for a system that overcomes the above problems, as well as one that provides additional benefits.

### BRIEF DESCRIPTION OF THE DRAWINGS

FIG. 1 is a block diagram that illustrates components of the wire tracking system in one embodiment.

FIG. 2 is a flow diagram that illustrates a method for automatically identifying the location of a wire in an image using the components described above in one embodiment.

FIG. 3 illustrates the typical motion of a wire over a sequence of images, such as frames of video.

FIG. 4 illustrates the application of gradients and blurring to the search region of an image.

FIG. 5 illustrates the search region of the image following the determination of the image gradient and blurring.

FIG. 6 illustrates candidate points within the image and candidate models identified for the points.

FIG. 7 illustrates a better fit for the wire based on the candidate points.

### DETAILED DESCRIPTION

### Overview

A wire tracking system is described that provides a method and system for automatically locating wires in a digital image and tracking the located wires through a sequence of digital images. The Foundry's Furnace 4 F_WireRemoval plug-in implements one embodiment of the wire tracking system. The wire tracking system is particularly good at removing wires from complex shots where background replacement is difficult. For example, the wire tracking system can automatically remove wires that cross actors or complex moving backgrounds like trees or smoke. Rather than relying on traditional edge-stitching or cloning techniques, the wire tracking system performs complex signal processing to automatically remove the wire from the original image while preserving grain and background detail. Thus, the wire tracking system provides a reliable method of automatically identifying wires and replacing the wires with a reconstructed background image, and frees the artists to make other enhancements to the scene.

The sections below describe in further detail a suitable system for implementing the wire tracking system, observations on which the system operates, a method of tracking wires in an image, two algorithms for identifying candidate wire models (RANSAC and LMA), and example images illustrating the operation of the wire tracking system.

### Suitable System

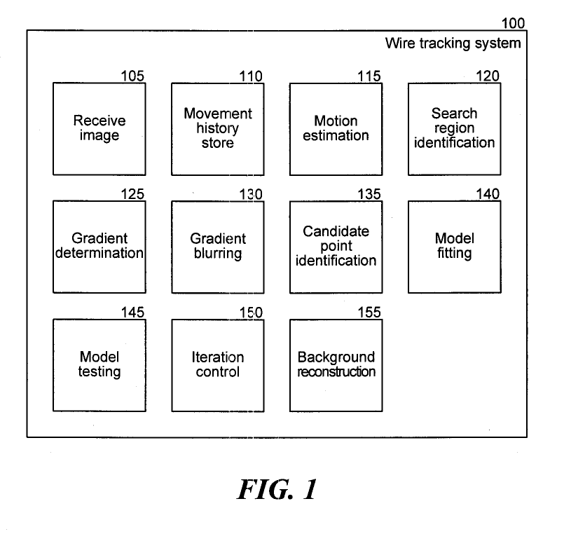

FIG. 1 is a block diagram that illustrates components of the wire tracking system in one embodiment. The wire tracking system 100 includes a receive image component 105, a movement history store 110, a motion estimation component 115, a search region identification component 120, a gradient determination component 125, a gradient blurring component 130, a candidate point identification component 135, a model fitting component 140, a model testing component 145, an iteration control component 150, and a background reconstruction component 155. Each of these components is described in further detail below.

The receive image component 105 receives an image or sequence of images in which an artist wants to remove a wire or wires. For example, the image may be received from a component that accesses a stored data file containing frames captured using a digital video camera. The movement history store 110 contains information stored about past images in a sequence. For example, if a wire has been previously identified and determined to be moving at a fairly constant rate of speed through a sequence of images, then the movement history store 110 may contain information about the past location of the wire and the direction and velocity at which it has been moving. The wire tracking system 100 may use this information to help identify the wire in a later image in the sequence. The motion estimation component 115 estimates the motion of identified wires through a sequence of images. For example, the motion estimation component may use common motion estimation techniques in the art to identify a motion vector that characterizes the motion of the wire at various points.

The search region identification component 120 identifies a bounded subset, called a search region, within an image in which a wire is expected to be found. The search region may be identified using the movement history store 110 and motion estimation component 115 to calculate a likely current position of the wire based on the wire's past position and movement characteristics. The search region identification component 120 may apply an error value to the estimated new position of the wire to allow for changes in motion that may have occurred from image to image in the sequence. This creates a bounded region in which the wire is expected to be found. Alternatively, if the component cannot identify a search region (such as because no historical information is available), then the component may guess a region to search or choose the entire image as the search region.

The gradient determination component 125 computes the image gradient of each pixel in a direction perpendicular to the expected direction of the wire. The gradient of an image is one of the fundamental building blocks in image processing. For example, gradients can be used for edge detection. Mathematically, the gradient of a two-variable function (here the image intensity function) is at each image point a 2D vector with the components given by the derivatives in the horizontal and vertical directions. At each image point, the gradient vector points in the direction of largest possible intensity increase, and the length of the gradient vector corresponds to the rate of change in that direction.

The gradient blurring component 130 blurs the values of the image gradient in a direction parallel to the expected direction of the wire. This helps to reduce the influence of short objects in the scene that happen to have a strong edge in the same direction as the wire. For example, an object such as a leaf with an orientation parallel to the wire might easily be confused for the wire, even though it is short in comparison to the wire. By blurring the gradients in the direction parallel to the wire, the wire tracking system 100 reduces the influence of such short objects.

The candidate point identification component 135 identifies particular points in the gradient that are the best candidates for fitting a model of the wire. For example, the component may apply a nonmaximal suppression formula to the blurred gradient values, i.e., if a gradient value at a pixel is greater than the gradient at all of its surrounding pixels, the component may keep it or otherwise may set it to zero. The resulting points are candidate points used by the model fitting component 140.

The model fitting component 140 attempts to fit a model for the wire to the candidate points. For example, the component may try to fit a line through several (e.g., four) of the points or a parabola (if the wire is expected to be bent) through some (e.g., six) of the candidate points. The number of candidate points used to fit the model may be configurable by a user of the system. In some embodiments, the model fitting component 140 uses a random sample consensus (RANSAC) formula, described further below. RANSAC is an iterative method used to estimate parameters of a mathematical model from a set of observed data that contains outliers that do not precisely fit the model. The model fitting component 140 may choose from the candidate points at random or according to an ordered process and iteratively apply RANSAC to find better and better fitting candidate models.

The wire tracking system 100 uses the model testing component 145 to test each candidate model against the previous set of candidate models, and determine the current best candidate model. The iteration control component 150 determines how long the iterative process is allowed to proceed. RANSAC may be unbounded, so the component may stop after a specified number of iterations and report the best model identified.

The background reconstruction component 155 takes the candidate model determined by the previous components and operates to remove the modeled object from the image. For example, if the object is a wire and the model describes the location of the wire in the image, then the background reconstruction component 155 replaces the locations in the image having the wire with background that fits with the rest of the background. For example, the component may identify corresponding pixels in previous and subsequent images in a sequence that contain the data obscured by the object in the current image and copy this data to the current image. In this way, the wire tracking system 100 automatically identifies and removes wires from the image or sequence of images.

The computing device on which the wire tracking system 100 is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the wire tracking system 100 may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The wire tracking system 100 may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Observations

The wire tracking system operates based on several observations. First, a wire is generally a long thin opaque or translucent object. Second, a straight line or a parabola can generally approximate the shape of a wire. Third, wires generally have a well-defined edge. Although wires are often motion blurred at their edges, the shutter speed of film cameras often means that a strong defined edge is still visible. Fourth, wires will have a similar width from one frame to the next. This is generally true because the wires do not change physically. However, some amount of variance in width can occur due to differing amounts of motion blur between frames.

Fifth, a wire generally moves in a direction perpendicular to its axis from frame to frame. The wire is often anchored at a fixed point at one end and attached to the actor or other object at the other end. The actor will normally move but the anchor point will not, meaning the wire will be rotating around a point. Given that the wire is likely to be long in comparison to the movement of the actor within a single frame (e.g., 1/24th second), the rotation will be small. Thus, it is fair to use the assumption that a wire in one frame will have an orientation roughly parallel to its orientation in the previous frame (i.e., just a small perpendicular shift). Sixth, wires move in a predictable manner as acceleration is roughly constant from one frame to the next. Given that a frame only represents a small amount of time (e.g., 1/24th second), this is a reasonable assumption. Otherwise, if an actor were on the wire, a strong change in acceleration within this period would be rather hazardous. Thus, given that a wire has moved a certain perpendicular distance in one frame, it is likely that the motion will be similar in the next frame.

In short, observations one to four mean that given a rough location and orientation for a wire, the wire tracking system can detect its actual location by looking for well-defined edges that approximate a straight line or parabola, separated by a distance consistent with the width of the wire. Moreover, given a location for a wire in a previous frame, the fifth observation means that in the current frame the wire tracking system will find the wire shifted by some distance perpendicularly. Based on the sixth observation, if the previous location of the wire is known, the wire tracking system can predict its current location.

### Wire Tracking Method

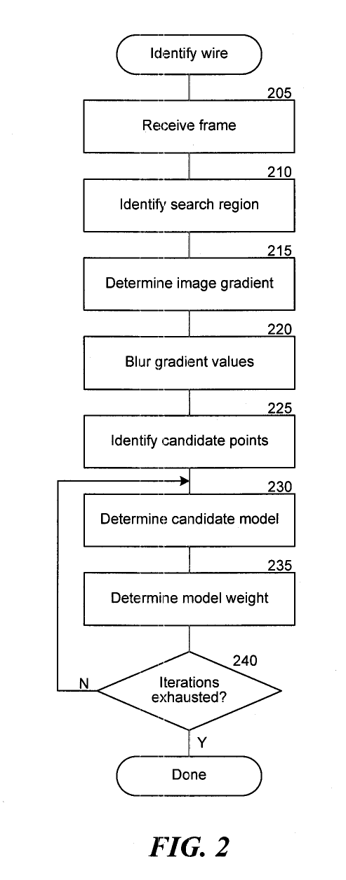

FIG. 2 is a flow diagram that illustrates a method for automatically identifying the location of a wire in an image using the components described above in one embodiment. To find the wire in the current frame, n, the wire tracking system proceeds as follows. In block 205, the system receives an image, such as a frame of video. In block 210, the system identifies a subset of the image to search for the wire, called a search region. For example, the system may identify the search region based on the location of the wire in the previous frame (n−1) and the expected motion of the wire. The system can find the expected motion using the mean and variance of the wire's movement history. If there is no history, then the system may arbitrarily guess the size of the region to search or search the entire image. In block 215, for each pixel, P, in the search region, the system determines the magnitude of the image gradient based on the closest point on the wire, W, at frame n−1, in the direction perpendicular to the wire at W. In block 220, the system blurs the values of the image gradients in a direction parallel to the wire. This helps to reduce the influence of short objects parallel to the wire, such as tree trunks or other objects in the background.

In block 225, the system applies one or more criteria to identify the most likely points in the image to be part of the wire, called candidate points. For example, the system may apply a process of nonmaximal suppression to the blurred gradient values, i.e., if a gradient value at a pixel is greater than the gradient at all of its surrounding pixels, keep it, otherwise, set it to zero. In block 230, the system tries to fit either a linear or a parabolic model to the candidate point's gradients using RANSAC or another formula. For example, the system may randomly pick points from the nonzero gradients (e.g., six for the parabola and four for the linear model). These random points define a candidate model for the wire. In block 235, the system tests the candidate model by determining how well it agrees with the other gradients and how well it agrees with the predicted shape and orientation of the wire.

To determine how well the model agrees with the other gradients, the system may count how many of the nonmaximally suppressed gradients lie on the candidate wire edges—these are the inliers. Then the system may multiply this inlier weight by a likelihood value, determined by how similar the candidate model is to the wire found in previous frames. For example, if the wire has been 10 pixels wide for the last four frames and this model suggests a wire 100 pixels wide, the likelihood value is low. This produces a final candidate weight. If the candidate weight is higher than previous candidate weights, then the system stores this candidate weight as the current best candidate weight. In decision block 240, if a threshold number of iterations has been reached or the candidate model weight is high enough, then the system completes, else the system loops to block 230 to determine the next candidate model. When the system completes, it reports the best candidate model identified as the location of the wire.

### RANSAC

RANSAC, as described above, is an iterative method to estimate parameters of a mathematical model from a set of observed data that contains outliers. A basic assumption of the RANSAC method is that the data consists of “inliers” (i.e., data points that can be explained by some set of model parameters) and “outliers” (i.e., data points that do not fit the model). The data points may be subject to noise. The outliers can come from, for example, extreme values of the noise or from erroneous measurements or incorrect hypotheses about the interpretation of the data. RANSAC assumes that, given a (usually small) set of inliers, there exists a procedure that can estimate the parameters of a model that explains or fits this data. A simple example is fitting a 2D line to a set of observations. Assuming that this set contains inliers (points that can be fitted approximately to the line) and outliers (points that cannot be fitted to the line), a simple least squares method for line fitting will, in general, produce a line with a bad fit to the inliers. The reason is that it is fitted to all points, including the outliers. RANSAC, on the other hand, can produce a model that is only computed from the inliers, provided that the probability of choosing only inliers in the selection of data points is sufficiently high.

RANSAC achieves its goal by iteratively selecting a random subset of the original data points. These points are hypothetical inliers and this hypothesis is then tested as follows. A model is fitted to the hypothetical inliers, that is, all free parameters of the model are reconstructed from the point set. All other data points are then tested against the fitted model, that is, for every point of the remaining set, the algorithm determines how well the point fits to the estimated model. If it fits well, that point is also considered as a hypothetical inlier. If enough points have been classified as hypothetical inliers relative to the estimated model, then the identified model is reasonably good. However, it has only been estimated from the initial set of hypothetical inliers, so we reestimate the model from the entire set of points' hypothetical inliers. At the same time, we also estimate the error of the inliers relative to the model.

This procedure is then repeated a fixed number of times, each time producing either a model that is rejected because too few points are classified as inliers or a refined model together with a corresponding error measure. In the latter case, we keep the refined model if its error is lower than the last saved model.

### Levenberg-Marquardt Algorithm

In some embodiments, the wire tracking system uses the Levenberg-Marquardt Algorithm (LMA) instead of RANSAC to identify a model for the wire from a set of candidate points. In mathematics and computing, the LMA provides a numerical solution to the problem of minimizing a function, generally nonlinear, over a space of parameters of the function. These minimization problems arise especially in least squares curve fitting and nonlinear programming. The LMA interpolates between the Gauss-Newton algorithm (GNA) and the method of gradient descent. The LMA is more robust than the GNA, which means that in many cases it finds a solution even if it starts very far from the final minimum. Like other numeric minimization algorithms, the LMA is an iterative procedure. To start a minimization, the user has to provide an initial guess for the parameter vector. In many cases, an uninformed standard guess will work fine; in other cases, the algorithm converges only if the initial guess is already somewhat close to the final solution.

In some embodiments, the wire tracking system selects RANSAC or LMA based on the historical speed of the two to save computation time. In addition, one method may be selected because it provides additional useful data. For example, the LMA can be used to fit a triangular profile to the perpendicular gradients, which also yields the extent to which the wire was motion blurred at its edges. This additional information may be useful in some contexts, and thus the LMA may be selected when this additional information is requested.

### Example Images

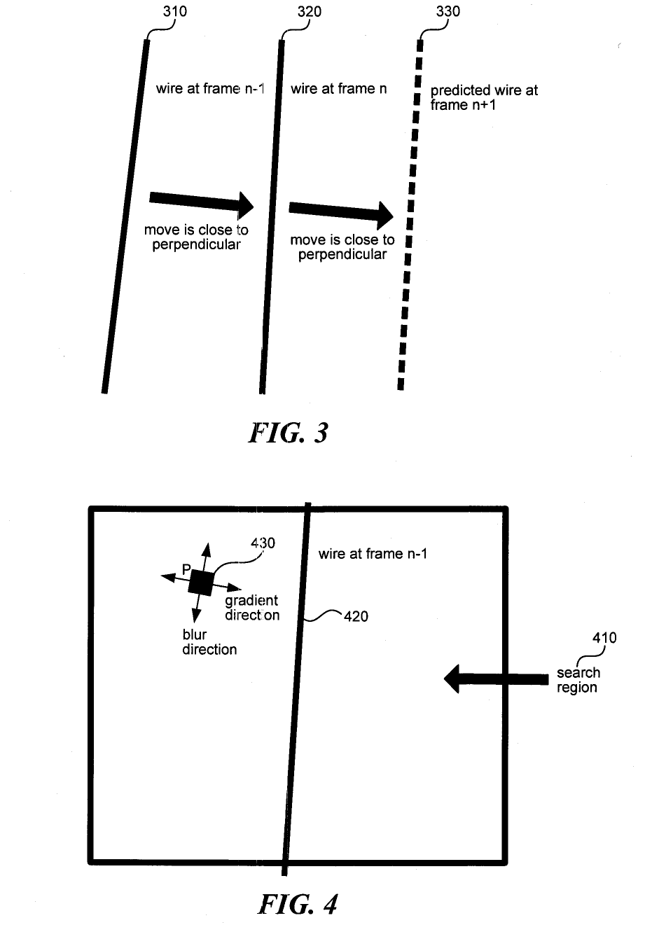

FIGS. 3-7 graphically illustrate the application of the above-described methods to an image.

FIG. 3 illustrates the typical motion of a wire over a sequence of images, such as frames of video. The wire is in location 310 in frame n−1, then is shifted slightly to the right to location 320 in frame n. In frame n+1, the next frame, the wire tracking system predicts that the wire will be at location 330 based on the observed motion and previous location of the wire. The wire tracking system may use this prediction to narrow the search region and to score candidate models for the wire.

FIG. 4 illustrates the application of gradients and blurring to the search region of an image. The search region 410 is an area to each side of the previous location 420 of the wire. If the motion of the wire is known, then the search region may be simplified to include only one side of the wire. For each pixel P 430, the wire tracking system determines the image gradient based on the previous location of the wire in the direction perpendicular to the wire. Then, the system blurs the values of the gradient in the direction parallel to the wire.

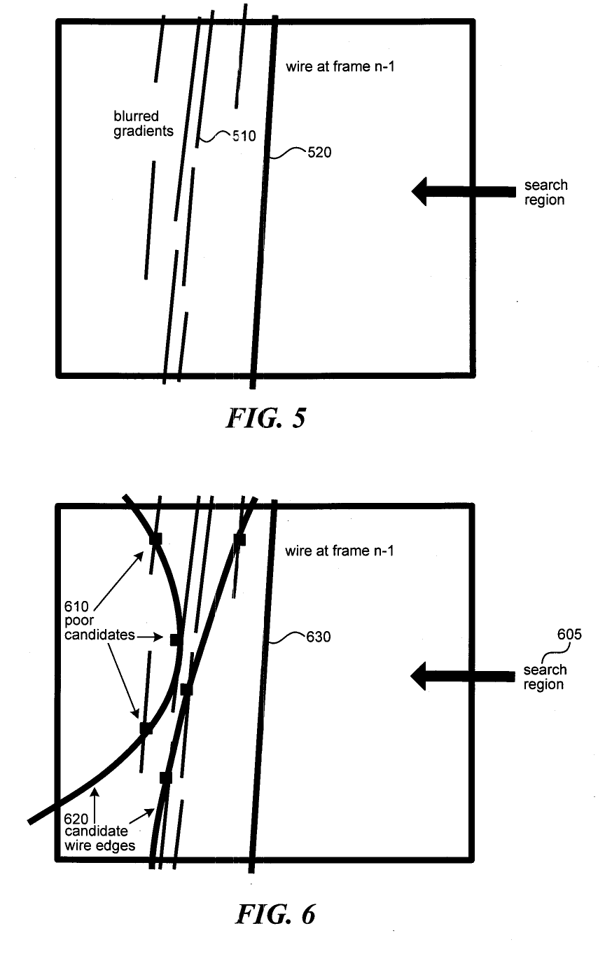

FIG. 5 illustrates the search region of the image following the determination of the image gradient and blurring. The blurred gradients 510 represent those objects in the image parallel to the previous location of the wire 520 and sufficiently long to have a high gradient value after blurring.

FIG. 6 illustrates candidate points within the image and candidate models identified for the points. The search region 605 contains candidate points 610 and candidate models 620 for the wire edges that fit the candidate points. These particular candidate points 610 provide candidate models 620 for the wire edges that are a poor fit for the wire based on the previous location 630 of the wire and the observation that the wire generally moves in a direction perpendicular to its length from image to image.

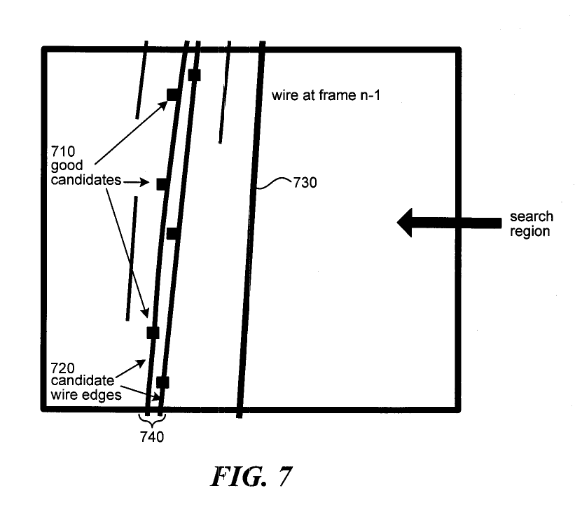

FIG. 7 illustrates a better fit for the wire based on the candidate points. The candidate points 710 provide candidate models 720 for the wire edges that are much better than those in FIG. 6. The candidate models 720 identify a location for the wire that is parallel to the previous location 730 of the wire. In addition, the width 740 between the two candidate models for the wire edges closely matches the width of the wire 730 in the previous frame. Thus, in the iterative process of identifying models described herein, the candidate models 720 of FIG. 7 will produce a higher score than those of FIG. 6 and will be the models selected by the wire tracking system.

### CONCLUSION

From the foregoing, it will be appreciated that specific embodiments of the wire tracking system have been described herein for purposes of illustration, but that various modifications may be made without deviating from the spirit and scope of the invention. For example, although wires have been used as examples of objects tracked by the system, the wire tracking system can also be used to track and/or remove any long, thin, straight, or curved objects, such as film scratches or other artifacts. Moreover, the wire tracking system can easily be adapted to fit a different model to the wires in addition to the linear and parabolic models described herein. For example, the wire tracking system could track the wire as a five-point piecewise cubic curve (this would be useful if there was a lot of slack in the wire). Those of ordinary skill in the art will recognize that these and other models can easily be used with the system described herein. Accordingly, the invention is not limited except as by the appended claims.

I/we claim:

1. A computer-based method for automatically identifying wires in a frame of video, the method comprising:
receiving the frame of video, wherein the frame contains at least one wire used to support an actor or other object when the frame was captured, the frame being made up of pixels;
identifying a search region within the received frame that is likely to contain the wire based on a previous location and motion of the wire in a previous frame of video;
determining an image gradient at each pixel within the search region in a direction perpendicular to the previous location of the wire;
blurring a gradient value for each pixel in a direction parallel to the previous location of the wire to reduce confusion with objects having a similar direction to the wire that are short relative to the length of the wire;
identifying candidate points based on the blurred gradient values that are likely to identify the edge of the wire;
determining a candidate model based on the identified candidate points using a model fitting formula;
determining a score for the candidate model based on the previous location and motion of the wire; and
repeating the previous steps until an iteration threshold has been reached; and
when the iteration threshold has been reached, reporting the candidate model having the highest score as the identified location of the wire in the frame of video.

2. The method of claim 1 wherein the model fitting formula uses a RANSAC method.

3. The method of claim 1 wherein the model fitting formula uses a Levenberg-Marquardt algorithm.

4. The method of claim 1 further comprising predicting a next location for the wire in a subsequent frame of video based on the identified location of the wire in the frame.

5. The method of claim 1 wherein the model fitting formula fits a linear model to the identified candidate points.

6. The method of claim 1 wherein the model fitting formula fits a parabolic model to the identified candidate points.

7. The method of claim 1 wherein the number of candidate points used by the model fitting formula is configurable.

8. The method of claim 1 wherein determining a score for the candidate model comprises determining a width of the wire based on the model and comparing the width to a previous width of the wire in a previous frame.

9. The method of claim 1 wherein determining a score for the candidate model comprises determining a direction of the wire based on the model and comparing the direction to a previous direction of the wire in a previous frame.

10. The method of claim 1 wherein the model fitting formula ignores outliers that do not fit the candidate model.

11. A computer system for editing a digital video to remove wires or other artifacts during post-production, the system comprising:
an image receiving component configured to receive an image in a sequence of images within the digital video;
a movement history store configured to store the determined location and movement of an artifact in previous images;
a motion estimation component configured to predict the location of the artifact in subsequent images;
a candidate point identification component configured to identify points within the image likely to contain the artifact;
a model fitting component configured to fit one or more models that describe the edges of the artifact to the identified points within the image and identify a selected model that provides a likely location for the artifact within the image; and
a background reconstruction component configured to remove the artifact from the image based on the likely location provided by the selected model and replace the artifact with background pixels that relate to neighboring background pixels.

12. The system of claim 11 wherein the model fitting component uses a random sample consensus formula to iteratively determine the one or more models.

13. The system of claim 11 wherein the candidate point identification component is further configured to determine a gradient of each pixel in a direction of a previous location of the wire and to reduce the gradient value in the direction parallel to the direction of the previous location of the wire.

14. The system of claim 11 wherein the model fitting component performs a fixed number of iterations to determine the selected model.

15. The system of claim 11 wherein the model fitting component determines a score for each model and assigns a lower score to models that do not correlate well to information stored in the movement history store.

16. A computer-readable storage medium encoded with instructions for controlling a computer system to automatically identify an object present in a digital image made up of pixels, by a method comprising:
determining an image gradient based on a likely direction of the object in the digital image;
modifying a gradient value for each pixel in the digital image in a direction parallel to the likely direction of the object in the digital image;
determining multiple models that fit points within the image having a high gradient value, each model having a candidate weight;
determining a best model based on the candidate weight of each determined model.

17. The computer-readable medium of claim 16 wherein determining multiple models comprises applying a RANSAC formula to include inliers and exclude outliers in the models.

18. The computer-readable medium of claim 16 wherein determining an image gradient comprises examining a historical location of the object in a previous digital image.

19. The computer-readable medium of claim 16 wherein determining multiple models comprises performing a number of iterations to select models and stopping when the candidate weight reaches a threshold.

20. The computer-readable medium of claim 16 wherein the candidate weight is based on observations about typical characteristics of the object.
